(19) United States
(12) Patent Application Publication
(10) Pub. No.: US 2012/0112900 A1
(43) Pub. Date: May 10, 2012

(54) SAFETY BELT COMPLIANCE INDICATOR

(76) Inventors: James Garofalo, Peekskill, NY (US); Marlo Rae Trainhan, Poughquag, NY (US); Edward Joseph Pavone, Poughquag, NY (US); Troy Jeffrey Tompkins, Yorktown, NY (US); Dina Marie Tompkins, Yorktown, NY (US)

(21) Appl. No.: 12/941,405

(22) Filed: Nov. 8, 2010

(51) Int. Cl. B60Q 1/26

(52) U.S. Cl. 340/468

(57) ABSTRACT

The present invention provides methods and apparatus for operating a wireless signal indicating safety belt compliance. The wireless signal may in turn cause a visual indicator that is ascertainable from a position external to the vehicle to indicate safety belt compliance.

### FIELD OF THE INVENTION

The present invention relates to methods and apparatus for providing one or more of: a visual indicator of safety belt compliance, a recording device that records the use of seat belts during motor vehicle operation and a device to notify a third person such as a guardian of non-compliance of seat belt use during operation of a motor vehicle. More specifically, the present invention presents apparatus and methods for providing an indicator observable via one or more of: a human eye, a traffic monitoring camera, infrared scanner, a wireless monitor or other device congruent with a transmitted signal, wherein the indicator signals a buckled or an unbuckled state of a safety belt associated with an occupied seat in a vehicle.

### BACKGROUND OF THE INVENTION

To date, it has been known to equip motor vehicles with safety belts, such as seat belts and cross body harnesses. Proper use of a safety belt has been left largely up to the operator of the vehicle and the vehicle passengers. More recently, authorities have legislated mandatory use of safety belts for operators of a vehicle used on public roadways and for passengers in the front seat of such vehicles. Proper use of safety belts becomes even more important in vehicles with air bags, in that an air bag deployment without a fastened safety belt may increase the incidence of injury for a vehicle operator and passenger.

Seat belt use has been proven to improve safety and save lives. Better compliance with seat belt use would therefore provide a public benefit.

Although police officers have the right to ticket violators of the seat belt laws, it is often difficult for an officer to determine if a seat belt is being worn or not. Consequently, compliance with seat belt laws is again largely left up to the operator of the vehicle, and to a lesser degree the passengers of the vehicle. In some instances, someone other than a police officer may be interested in the safety of a vehicle driver or passenger. In those instances, it would be beneficial for that person to be able to determine if a seat belt is being worn while a vehicle is being operated.

What is needed therefore is a means for indicating proper safety belt use and proof of same and thereby share seat belt compliance with others besides the vehicle operator.

### SUMMARY OF THE INVENTION

Accordingly, the present invention provides apparatus and methods for providing a remote indication of seat belt compliance while a vehicle is being operated and a record of compliance or non-compliance via a recording device.

In some embodiments, a record of compliance or non-compliance may be forwarded to a third party, such as a guardian of a vehicle driver, wherein the record indicates compliance of the vehicle driver's and vehicle passenger proper use of safety belts. Although various embodiments may include sensors and hardware for determining an unsafe condition, such as operation of a vehicle without a safety belt fastened, preferred embodiments include monitoring of onboard diagnostics and logic which determines if a predetermined condition is being met. In the event that a predetermined condition is met, additional logic determines a responsive action. Responsive action may include, by way of example, illumination of a light ascertainable from a position external to the vehicle, generalized transmission of a wireless signal to an area proximate to the vehicle, transmission of a signal to a predetermined destination distal to the vehicle.

Some embodiments include visual indicators located internal to a vehicle and/or external to the vehicle. The visual indicators may be activated based upon a wireless signal. In addition, the visual indicators may be within the humanly visibly light spectrum for visual perception by a human, or outside of the humanly visible light spectrum and congruent for use with receivers tuned to receive a signal in the wavelength utilized.

### BRIEF DESCRIPTION OF THE DRAWINGS

As presented herein, various embodiments of the present invention will be described, followed by some specific examples of various components that can be utilized to implement the embodiments. The following drawings facilitate the description of some embodiments:

FIG. 1 illustrates a diagram of vehicle with exemplary visual indicators of seat belt compliance.

FIG. 2 illustrates block diagram of elements of some embodiments of the present invention.

FIG. 3 illustrates some exemplary steps that may be practiced in some embodiments of the present invention.

FIG. 4 illustrates various embodiments of the present invention including a light bar or light tube.

FIG. 5 illustrates an end view of some exemplary connector interceptor.

FIG. 6 illustrates a top down view of some exemplary connector interceptors.

FIG. 7 illustrates an exemplary connector interceptor attached to a signal bearing cable to a circuit board packaged.

### DETAILED DESCRIPTION

The present invention provides methods and apparatus for providing one or both of an indication and a notification of a compliance event related to operation of a vehicle. The compliance event may include safety belt compliance during operation of the vehicle.

Various embodiments include an indicator, such as a light or other illuminated device visible from a position rearward of the vehicle or forward to the vehicle. For example, one or more lights may be located internal to a vehicle and visible through one or more of: a frontward window, a rear window or external to the vehicle, such as, proximate to a license plate or tag. In some embodiments, the indicators are color coded to indicate seat belt compliance within the motor vehicle. Various embodiments may include apparatus to provide an indication of safety belt compliance that is installed as original equipment in a vehicle or alternatively in the secondary market. Generally, the indicator is ascertainable from a point external to the vehicle, although embodiment may exist wherein the indicator is ascertainable from a position internal to the vehicle.

A safety belt compliance indicator and notification device may signal to an authority, such as a police officer or other authority, or other interested party, such as a parent or guardian of a vehicle operator, as to whether a safety belt is properly fastened for each respective person within the motor vehicle during vehicle operation.

Generally, as referred to herein, an indicator refers to a device ascertainable from a position proximate to a vehicle. A notification device refers to a device that receives information related to the

Some embodiments may therefore provide a warning to a police officer or other person, that is approaching a stopped vehicle, that one or more of the occupants has disengaged a safety belt. Knowledge that a vehicle occupant has disengaged a safety belt can inform an approaching police officer of a possible intent by the disengaging vehicle occupant to act in a fight or flight fashion. Moreover, if a data storage device is utilized in conjunction with the indicator, it becomes possible to gather information that may be helpful for investigative purposes. The recorded information may be provided to concerned vehicle owners, such as parents, and in some embodiments, to law enforcement and insurance companies in an effort to educate the public of the potential for injury, and even fatalities related to vehicle operation.

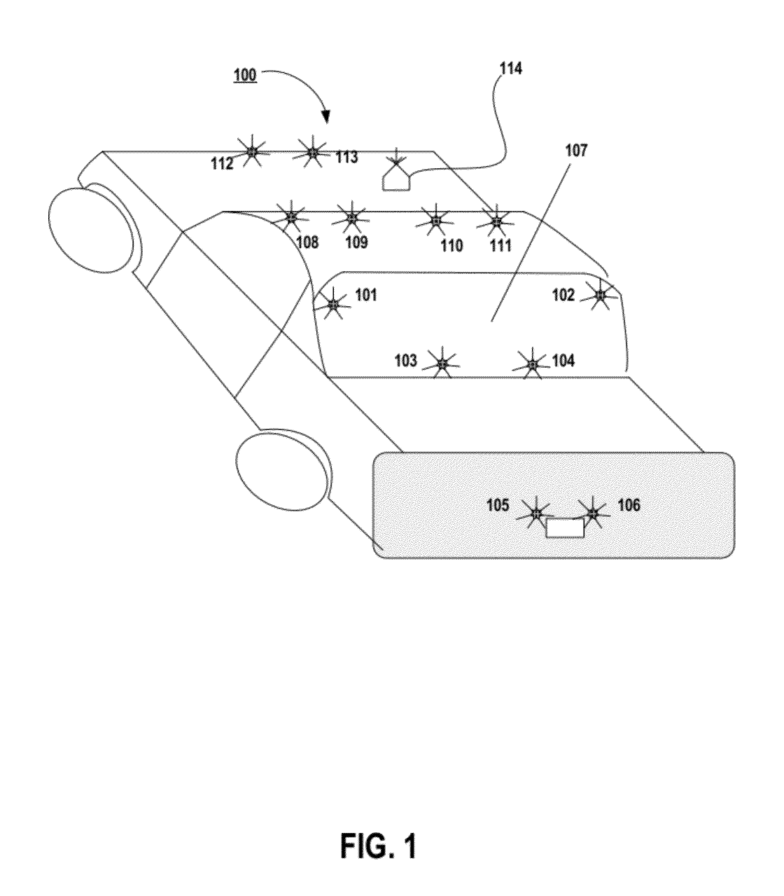

Referring now to FIG. 1, in some embodiments of the present invention, a motor vehicle such as an automobile 100 will have one or more visual indicators 101-113. The visual indicators provide a signal ascertainable from a point external to the vehicle 100. Ascertainable may include one or more of: being viewable by a human eye; readable by a scanner tuned to a desired frequency; viewable by a camera sensitive to predetermined wavelength of light, or other device that will recognize a signal emanated from indicators 101-113. The visual indicators 101-113 may include, for example: one or more light bulbs, one or more light emitting diodes, a polygon array of light emitting diodes; a linear array of light emitting diodes; a tube of light bulbs; or other apparatus capable of generating light based upon a logical command or an electrical or light signal.

In some embodiments, the visual indicators 101-113 will emit light with a wavelength within a humanly visible light spectrum. In other embodiments, in order to not confuse the light emanated by the visual indicators 101-113 with other light signals used during operation of the vehicle, the visual indicators 101-113 may emanate light outside a visible light spectrum for human beings. In such embodiments, a police officer or other interested party may utilize eyewear that processes the non-visible light waves and allows human sight to view light emanated by the visual indicators 101-113.

For example, in some embodiments, the visual indicators 101-113 may emanate an infrared light signal to indicate non-compliance of safety belt use. The police officer may then use infrared night vision goggles or an infrared camera to view the visual indicators 101-113. Light radiation outside the visible spectrum may also pulse or flash to further alert a police officer. In addition, a non-visible light may be shown in all directions so that a police officer or other individual with correct eyewear may see the indicator light from any direction.

Some visual indicators 101-104 may be located within the vehicle 100 and viewable, for example through a rear window 107 of the vehicle 100. The indicators may also be viewable via other windows of the vehicle. Some embodiments may also include one or more visual indicators 105-106 that are located exterior to the vehicle. For example, the indicators 105-106 may be proximate to a license plate or tag. Still further embodiments include visual indicators 108-111 internal to the vehicle 100 and viewable via a front windshield, or visual indicators 112-113 viewable from a position forward of the vehicle 100

Most states require that a license plate be illuminated by a dedicated light source 105-106. According to the present invention, a license plate light source 105-106 may be color coded according to safety belt compliance or safety belt non-compliance. For example, a yellow license plate light source 105-106 may indicate proper safety belt compliance by a vehicle operator or passenger and a red or blue light may indicate non-compliance by a vehicle operator or passenger. Other color codes or schemes may also be utilized. In some embodiments, a light color may distinguish between compliance for a passenger and an operator.

Some embodiments may also include a pattern of flashing visual indicators 101-113 to signify compliance or noncompliance of safety belt use. For example, the visual indicators may always remain a same color and a steady state of light emanation may indicate compliance with safety belt use and a flashing pattern may indicate non-compliance of safety belt use.

In still other embodiments, a data storage device may store a record of compliance with safety belt use. The data storage may include, for example, a random access memory (RAM) or other semiconductor storage, magnetic disk storage or other device for data storage. The record may store a chronological history over a period of time, such as, for example a number of hours of vehicle use, or a calendar period, such as for example, a past week or month.

Still other embodiments may include an audio signal generated outside of the vehicle and loud enough to alert others in general proximity of the vehicle that the vehicle is being operated in a fashion non-compliant with safety belt use. For example, a series of tones may be generated similar to a series of tones to warn people in proximity to a vehicle that a vehicle is backing up. Other embodiments may include a pattern of horn blasts.

In another aspect a notification device 114 may generate a signal that is directed to a destination distal to the vehicle 100. The signal may include, for example a cellular telephone transmission. Cellular transmission may include well known standards including, for example, 2GT, 3GT, 4GT or other standard adopted by the International Telecommunication Union.

In some embodiments the cellular telephone transmission may include data displayable via a user interface, other embodiments may include an audible message, such as voice message, including for example a digital emulation of a human voice. Other notification devices 108 may include a short band or citizens band radio transmission or transmission in another wavelength authorized for such us by a governing body.

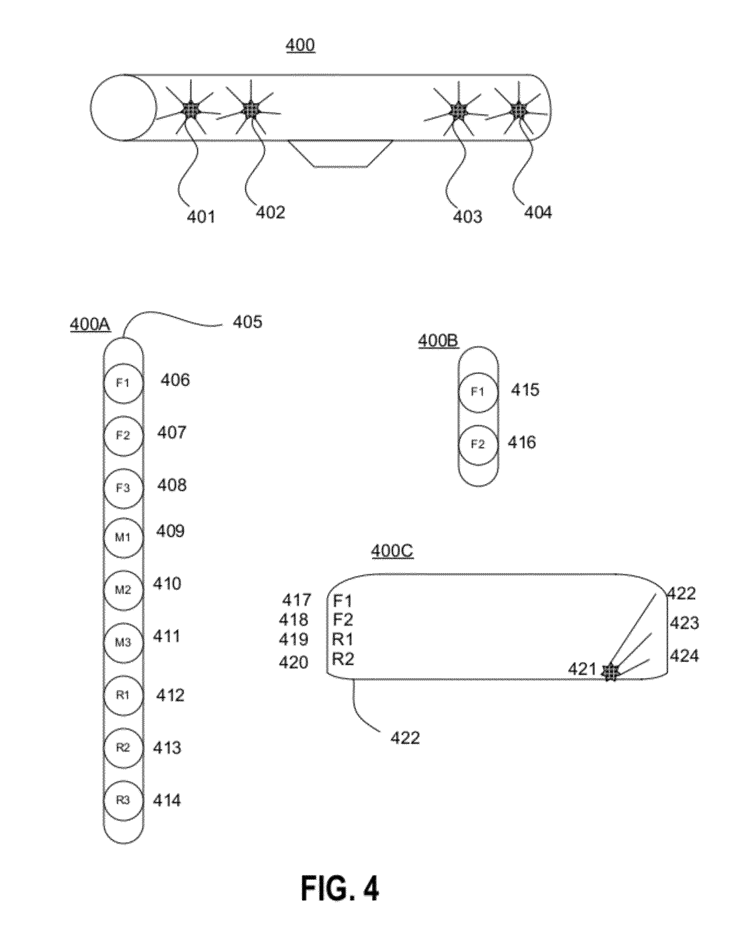

Referring now to FIG. 4, in some embodiments, an array of lights 401-404 is linearly aligned, such as for example in a light bar 400. Linear arrays may be positioned horizontally, vertically or at an angle to a mounting surface. Embodiments may also include one or more particular indicators 401-404 associated with a particular safety belt in a vehicle. For example, a first indicator 401 may be associated with a drivers seat safety belt, a second indicator 402 may be associated with a rear seat on the drivers side of the vehicle, a third indicator 403 may be associated with a front seat passenger safety belt, and a fourth indicator 404 may be associated with a rear seat on the passenger side, and so on to include all allowable seats within a motor vehicle.

Embodiments that include one or more particular indicators 401-404 associated with a particular safety belt allow a police officer or other party to ascertain from a position exterior to a vehicle, which occupants are in compliance with safety belt use and which are non-compliant.

In some embodiments, a vertical array 400A-400C of indicators 406-420 can include individual indicators each associated with a respective seat in a vehicle. A 400A a vertical array of indicators 405 is illustrated for a larger vehicle with nine seats and includes individual indicators 406-414 each associated with a respective seat in the vehicle. For example, an F1 indicator 406 can correspond with a driver's seat o front one seat. An F2 indicator 407 can correspond with a middle front seat, and a F3 indicator can correspond with a front passenger seat. Similarly, M1 through M3 correlate with seats located in a mid-portion of a vehicle and R1-R3 can correlate with seats located in a rear portion of the vehicle.

At 400B a version for a two-seater vehicle is illustrated with an F1 indicator 415 correlating with a driver's seat and an F2 indicator 416 correlating with a passenger seat.

At 400C, in some embodiments one or more prisms or other markings or etchings 417-420 made be incorporated into a windshield 425. Each prism 417-420 may correlate with a specific vehicle seat. In some embodiments, one prism or etching may be made and portions of the etching correlate with each seat (not illustrated). Still other embodiments, include a projection device 421 which projects one or more human readable displays 422-424 on or near a wind shield 425. The projection acts as an indicator of safety belt compliance.

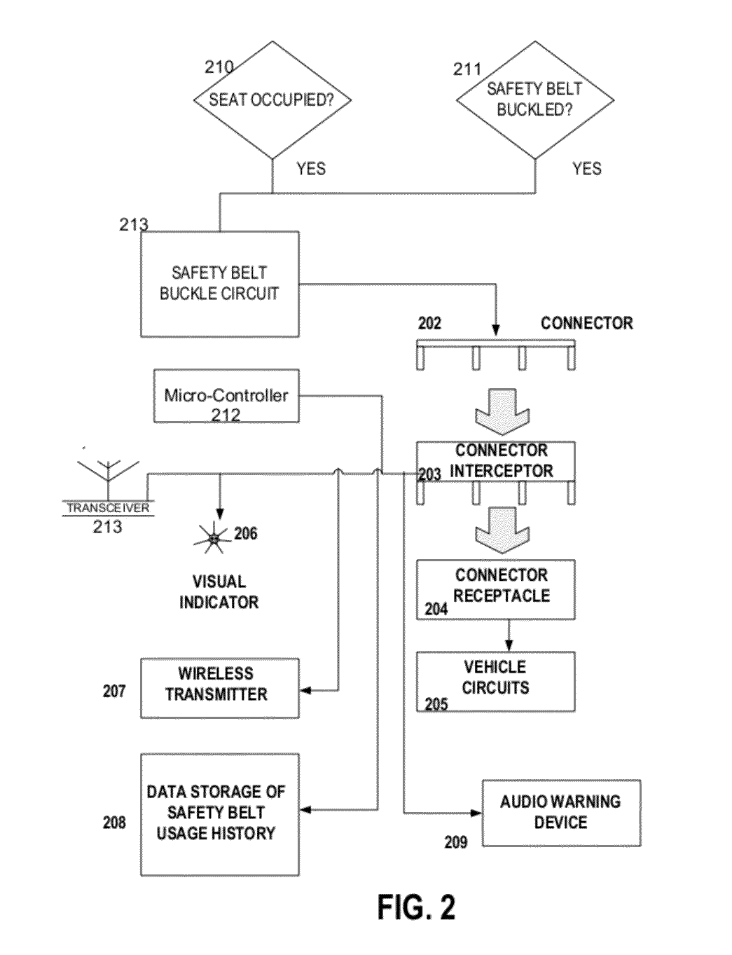

Referring now to FIG. 2, a block diagram illustrates components that may be used in some implementations of the present invention. At 201, a safety belt circuit 213 may be used to ascertain if a passenger occupying a seat in a vehicle has properly fastened a safety belt. Safety belt circuits 213 are well known and typically involve a first device to determine if a safety belt is fastened 210 and a second device to determine if a passenger is occupying a seat in a vehicle 211. The circuit 213 will combine electrical signals from the first device and the second device and if simple electrical component logic determines that a passenger is occupying a seat and that an associated safety belt is not fastened, then a current will be passed to a signal ascertainable to an operator of the vehicle signifying that a passenger is not in compliance with safety belt use. The signal will be processed by vehicle circuits, such as, for example, a dashboard message and/or an audio sound.

In some preferred embodiments, the safety belt circuit is included within an On Board Diagnostics II system (“OBD2”). As discussed further below, the OBD2 system includes a standardized connector 202 with predetermined pin out arrangements. Therefore a standardized connector interceptor 203 may be placed in electrical communication with the OBD2 connector connection pins.

In some embodiments, a connector 202 will include one or more wires carrying the current to a signal ascertainable to an operator of the vehicle signifying that a passenger is not in compliance with safety belt use. The connector 202 may be disconnected from a connector receptacle 204 and a connector interceptor 203 may be placed in between the connector 202 and the connector receptacle 204. The connector interceptor 203 may act as an endpoint for a connector 202 and any signals emanating from the connector 202 and in additional embodiments, the connector interceptor may be functional to pass currents between the connector 202 and the connector receptacle 204 and on to the vehicle circuits. The connector interceptor 203 will also be functional to pass an electrical current on to one or more of: a visual indicator 206; a notification device, such as a wireless transmission device 207; a micro-controller 212 and a data storage of safety belt compliance history 208.

The micro-controller 212 may be one or both of a) a pre-programmed or b) execute code stored on the data storage. Preferred embodiments will include a micro-controller that interfaces with an OBD2 connector and circuitry 205. Execution of code would enable the micro-controller to issue instructions for one or more of: causing a signal to be generated to power one or more visual indicators 206; transmit via a wireless transmitter 207; store data in a data storage 208; or other related function.

The connector interceptor 203 may also complete connections to the original connector receptacle 204 and associated vehicle circuits 205. In such embodiments, the connector interceptor provides a pass through for electrical signals.

One or both of the connector interceptor 203 and the microcontroller 212 will provide a signal to one or more of a visual indicator 206; a wireless transmitter 207; data storage device 208, an audio warning device 209 and a transceiver 213.

A wireless transmitter 207 typically includes a one way transmission of a signal. The signal will generally be multi-directional and proximate to the vehicle. Accordingly, a law enforcement or other authority may receive a signal form a vehicle while the vehicle is within a radius of a receiver or scanner operated by the authority. The distance that constitutes “proximate” may therefore based according to the strength of a signal transmitted and the sensitivity of the scanner receiving the signal. Some examples may include a scanner within approximately 300 yards of the wireless transmitter 207, other embodiments may include a scanner that receives a signal up to approximately 600 yards.

In another aspect a wireless transmitter 207 may transmit a signal to a visual indicator 101-113 mounted on or within the vehicle. The visual indicator 101-113 will have a receiver that receives the signal and provides an electrical current to an illumination device or other indicator.

In some additional embodiments, a transceiver 213 will transmit a signal to a programmed destination. The transceiver 213 is typically also able to received information, such as for example a command to download data stored within a microcontroller. One example of a transceiver is a cellular phone communication device. The transceiver 213 may be used to call, for example, a parent or guardian of a vehicle operator. In some particular embodiments, a transceiver may receive a command from a parent or guardian which causes.

It will be apparent to those skilled in the art that additional circuitry (not shown), such as a power circuit may be included and facilitate the provision of a signal to the visual indicator 206 which causes it to illuminate. The power circuitry may include, for example, a switching circuit which receives a logical signal from the micro-controller 212 and based upon such logical signal either provides electrical current to the visual illuminator 206 or removes the flow of electrical current to the visual illuminator 206.

With respect to the wireless transmitter 207, in some embodiments, some embodiments may also include one or both of the connector interceptor 203 and the microcontroller 212 providing a signal to the wireless transmitter 207 and based upon the signal from the one or both of the connector interceptor 203 and the microcontroller 212, the wireless transmitter 207 will transmit a signal to a wireless receiver 213. The wireless receiver 213 is functional, either alone with additional circuitry to provide electrical current to the visual illuminator 206 or to cease the provision of current to the visual illuminator 206. In some embodiments, the wireless receiver is embodied within a single package with the visual illuminator 206.

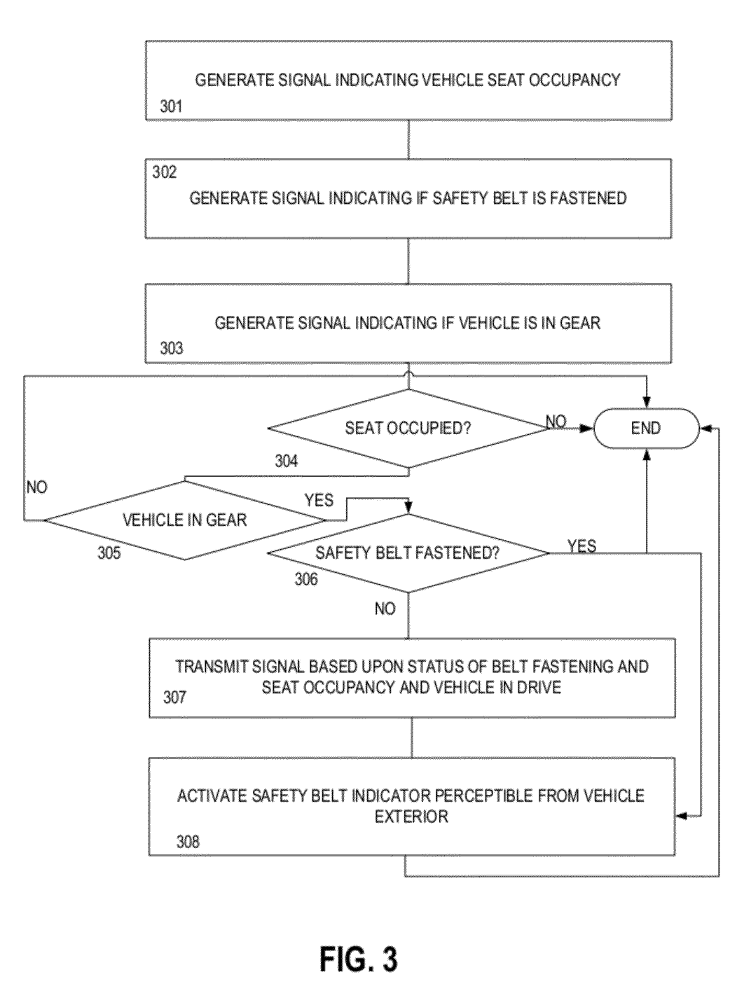

Referring now to FIG. 3, a flow diagram illustrates method steps that may be executed in some implementations of the present invention. At 310, a signal is generated which indicating the state of a vehicle seat occupancy. Generally, the signal is generated by a sensor device and an occupancy signal will include either an “on” state indicating that a seat is occupied, or an “off” state indicating that the seat is unoccupied. Circuitries for generating signals indicating the state of a vehicle seat occupancy are known in the art.

At 302, a signal is generated indicating whether a safety belt is fastened is generated. Generally, the signal is generated by a sensor device and a safety belt fastened signal will include either an “on” state indicating that a safety belt is fastened, or an “off” state indicating that the safety belt is unfastened. Circuitry for generating signals indicating the state of a vehicle safety belt is fastened are known in the art.

At 303, a signal is generated indicating whether the vehicle is in gear is generated. Generally, the signal is generated by a sensor device and a safety belt fastened signal will include either an “on” state indicating that a safety belt is fastened, or an “off” state indicating that the safety belt is unfastened. Circuitry for generating signals indicating the state of a vehicle safety belt is fastened are known in the art.

At 304-306 circuits receive the signals generated and perform a logical “AND” function. If signals indicate that the seat is occupied, and the vehicle is in gear, and the safety belt is not fastened, then according to the present invention, at 307, a signal is transmitted based upon the logic of 304-306.

At 308, a safety belt indicator is activated, wherein the safety belt visual indicator is perceptible from a position exterior to the vehicle. In some embodiments, the safety belt indicator is perceptible from at least a vehicle lengths away from the vehicle. A vehicle lengths is significant because it is a distance that another vehicle stopped beside or behind a vehicle may be. For example, a police car stopped behind a vehicle at a stop sign would be able to observe a visual indicator and ascertain that a driver in vehicle is not wearing a fastened safety belt.

In some embodiments, a safety belt visual indicator is perceptible from a position exterior to the vehicle and at least three vehicle lengths away from the vehicle. A distance of three vehicle lengths is significant because it is a distance at which a second vehicle may be traveling behind a first vehicle at relatively low speeds. In such embodiments, an occupant of the second vehicle is able to ascertain whether the driver of the first vehicle is wearing a fastened safety belt.

Still other embodiments include a safety belt visual indicator is perceptible from a position exterior to the vehicle and at least five vehicle lengths away from the vehicle. A distance of five vehicle lengths is significant because it is a distance at which a second vehicle may be traveling behind a first vehicle at relatively higher speeds. In such embodiments, an occupant of the second vehicle is able to ascertain whether the driver of the first vehicle is wearing a fastened safety belt, even while traveling at relatively high speed.

Although various state statutes may provide for a vehicle to have a maximum length of up to forty or fifty feet, for the purposes of this document, a vehicle length will be fifteen (15) feet, based on an approximate size of an average automobile.

As discussed above, some preferred embodiments of the present invention will include a visual indicator that emanates sufficient amounts of electromagnetic radiation within the visible light spectrum for an unaided human eye. Generally, a spectrum of visible light for humans is between 350 nm to 750 nm (wherein “nm” refers to a nanometer). However, it some embodiments, it may be desired to minimize an amount of light visible on an active street. In particular, in those embodiments that include flashing visible light indicators may become annoying, or even a distraction to drivers. Alternatively, additional and/or flashing lights may contribute to driver fatigue.

Therefore, some preferred embodiments include visual indicators that emanate light our side of the human visible light spectrum (350 nm to 750 nm). Such embodiments may include, a brighter signals being emanated, and therefore may be ascertainable from farther away from an indicator emanating them than a visible light spectrum indicator. Some examples of non-visible light indicators operate in the near infrared spectrum, the medium infrared spectrum and the far infrared spectrum (sometimes referred to as the Far Wavelength infrared). Still other wavelengths may also be utilized, such as, for example, ultraviolet light.

Receivers for detecting visual indicators may pick up a signal from a visual indicator in a spectrum or wavelength outside of the human visible light spectrum and provide another indication within the visible light spectrum. In some embodiments, the receiver may also provide an audible indicator of an activated visual indicator. A receiver may include, a camera with receptors tuned to the desired wavelength, such as, for example, an infrared camera, or night vision equipment. Some vehicles are currently available with night assisted vision displays (such as, for example, those available from General Motors, Honda, Toyota and Mercedes Benz) a visual indicator may be tuned to be ascertainable with the night vision assist equipment commercially available.

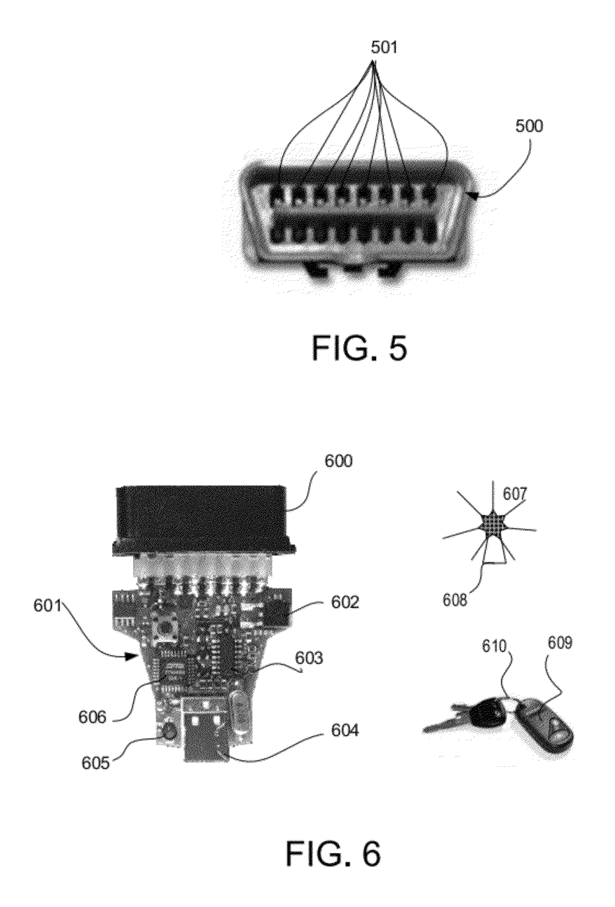

Referring now to FIG. 5, in some embodiments, a connector interceptor will interface with an OBD2 connector (sometimes referred to as “OBD II” or on board diagnostics two). An end on view is illustrated in FIG. 5 of some embodiments of an OBD2 connector interceptor 500 which includes one or more pin connections 501. Typically, each pin connection 501 will correlate with a signal. For example, in some embodiments, signal codes B1426 to B1430 relate to seat belt operation and may be picked up by a connector interceptor or other connection device.

Referring now to FIG. 6, a top down view of a connector interceptor 600 with a circuit board 601 included is illustrated without a protective casing. The circuit board may include, for example, a power source 602, such as a battery. There are many different types of batteries which may be included in embodiments of a connector interceptor of in powering an indicator 607. For example, batteries may be formed from various cathode and anode materials. By way of non-limiting examples these materials may include Zinc, carbon, Silver, Manganese, Cobalt, Lithium, Silicon. Still other embodiments include the use of batteries that are rechargeable at any time a car is operated. Such batteries may be formed via Lithium Ion, silver, magnesium, niobium, or other technology. It may be apparent to one skilled in the art that various current battery technologies for single use or rechargeable battery systems may comprise the power source in various embodiments of a connector interceptor 602.

The connector interceptor 601 may also include a microcontroller 606 to perform tasks such as interpreting signals received via the OBD2 connector 601, cause the transmission of an appropriate signal, direct information from one or both of the OBD2 connector and generated by the microcontroller 606 to a digital storage 603, direct digital data to a data connector 604 or other data processing function.

A transmitter 605 may be used to provide wireless transmission. In some embodiments, the transmitter will provide wireless transmission of a signal to an area proximate to a vehicle, as described above. In some embodiments, the transmitter will therefore communicate wirelessly to a visual indicator 607 located proximate to a vehicle on which the transmitter is installed. Variations of visual indicators 607 may be installed via different types of fasteners 608, such as, for example, a secure fastener, such as a push through connector, screw, nut and bolt, rivet or permanent adhesive. Other embodiments may include a semi-secure fastening mechanism, such as a removable adhesive, magnetic mount, hook and loop, snap, or similar means.

Although FIG. 6 illustrates components of the present invention 602-606 located on a board 601 in logical communication with the connector interceptor. While it is illustrated with the board 601 physically attached to the connector interceptor 600 it is within the scope of the invention to include some of those components on a separate device. Accordingly, various embodiments may include a transmitter 605 transmitting a wireless signal based upon an electrical current present in a connector 601.

A wireless transmission as used herein includes a transfer of information over a distance without the use of electrical conductors. The distances involved may be short (a few meters as in transmission to a visual indicator located on or in the vehicle) or long (many miles).

In some embodiments, the transmitter 605 transmits a wireless signal includes a multi-directional signal and in other embodiments, the transmitter 605 may transmit in a directional fashion. Transmitting in a directional fashion facilitates an enforcement agency identify which vehicle is transmitting a particular wireless transmission.

A processor 606 and associated digital storage 603 ad power source 602 may be located on a separate device, such as an enforcement scanner device, or even a separate module located with the vehicle, such as for example with a visual indicator 608. Numerous embodiments are therefore within the scope of the invention which include disparate location of the various parts of the invention described herein.

In another aspect of the present invention, in some embodiments, a wireless device 609 may be attached to a key ring 610 or other convenient location and identify an operator of a vehicle to the circuitry components 602-606 monitoring safety belt compliance. Data may be stored that indicates whether a particular vehicle operator enforces safety belt compliance while operating the vehicle. The data may also be transmitted via the transmitter 605 or downloaded from the storage 603 via the data connector 604.

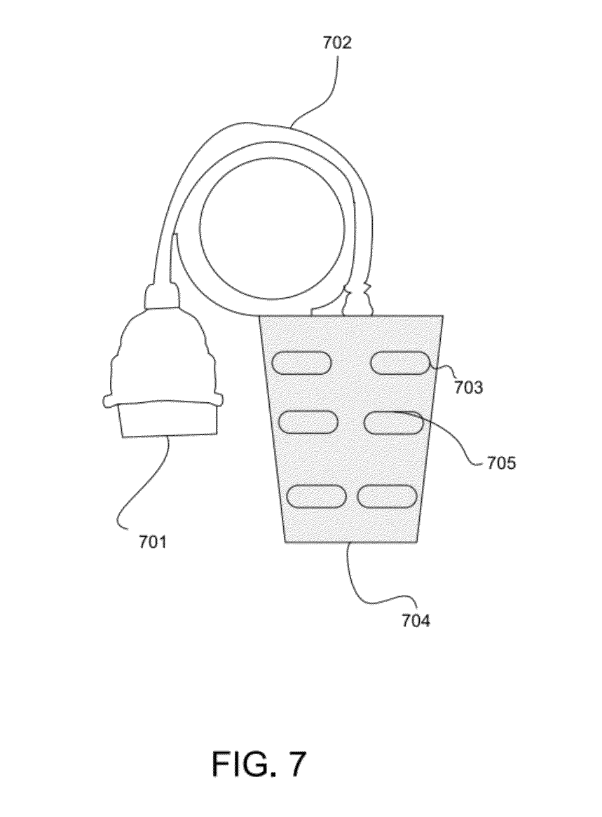

Referring now to FIG. 7, in some embodiments, a connector interceptor 701 is attached to a signal bearing cable 702 to a circuit board packaged in a protective casing 704. The circuit board and the casing 704 may include one or more user displays 703, wherein the user displays 703 provide information regarding the operation of one or both of the connector interceptor 701 and associated circuit board 704. A user operated control 705, such as a push button, may be used to cause a display 703 to provide information.

### CONCLUSION

A number of embodiments of the present invention have been described. Nevertheless, it will be understood that various modifications may be made without departing from the spirit and scope of the invention. For example, various methods or equipment may be used to implement the process steps described herein or to create a device according to the inventive concepts provided above and further described in the claims. In addition, various integration of components, as well as software and firmware can be implemented. Accordingly, other embodiments are within the scope of the following claims.

What is claimed is:

1. Automatic safety belt system apparatus for vehicular use, the apparatus comprising
a connector interceptor for attaching to a connector included in a vehicle, wherein the connector provides an electrical signal indicative of use of a safety belt during vehicle operation; and
a wireless transmitter for providing a wireless transmission of data indicative of safety belt compliance based upon the electrical signal indicative of use of a safety belt.

2. The safety belt system apparatus of claim 1 additionally comprising a visual indicator receiving the wireless transmission and providing an indication of safety belt compliance ascertainable from a position external to the vehicle.

3. The automatic safety belt system of claim 2 wherein the visual indicator emanates light radiation within the range of 380 nm to 750 nm.

4. The automatic safety belt system of claim 3 wherein said visual indicator comprises a light bulb located external to said vehicle.

5. The automatic safety belt system of claim 3 wherein said visual indicator comprises a light bulb located internal to said vehicle in a position wherein light emanating from said visual indicator is ascertainable from a position external to said vehicle.

6. The automatic safety belt system of claim 3 wherein said visual indicator comprises one or more light emitting diodes located external to said vehicle.

7. The automatic safety belt system of claim 3 wherein said visual indicator comprises one or more light emitting diodes located internal to said vehicle in a position wherein light emanating from said visual indicator is ascertainable from a position external to said vehicle.

8. The automatic safety belt system of claim 3 wherein said visual indicator comprises an array of light emitting diodes.

9. The automatic safety belt system of claim 1 additionally comprising a digital storage storing data indicative of safety belt compliance.

10. The automatic safety belt system of claim 1 additionally comprising a wireless identifier associated with a driver.

11. The automatic safety belt system apparatus of claim 2 wherein the visual indicator provides an indication of which seat is in compliance with safety belt use.

12. The automatic safety belt system apparatus of claim 11 additionally comprising a sensor generating a signal indicating whether the vehicle is in gear or not in gear and the visual indicator turns to a state ascertainable from a position external to the vehicle based upon the signal indicating whether a vehicle seat is in gear or not in gear.

13. The automatic safety belt system apparatus of claim 1 wherein the wireless transmitter comprises a transmitter capable of transmitting a cellular phone signal to a predetermined destination.

14. The automatic safety belt system apparatus of claim 13 additionally comprising a wireless receiver receiving said transmitted signal and generating a human readable display indicating safety belt compliance.

15. The automatic safety belt system apparatus of claim 1 wherein the state ascertainable from a position external to the vehicle comprises a position at a distance equal to one or more vehicle lengths.

16. The automatic safety belt system apparatus of claim 1 wherein the state ascertainable from a position external to the vehicle comprises a position at a distance equal to three or more vehicle lengths.

17. The automatic safety belt system apparatus of claim 1 wherein the state ascertainable from a position external to the vehicle comprises a position at a distance equal to five or more vehicle lengths.

18. The automatic safety belt system apparatus wherein the wireless transmission comprises a signal compliant with one or more of: 2GT, 3GT and 4GT standards.

19. The automatic safety belt system apparatus of claim 1 wherein the wireless transmission comprises a signal capable of reception by a visual indicator located proximate to the vehicle.

20. The automatic safety belt system apparatus of claim 19 wherein the visual indicator is located within the vehicle and visible external to the vehicle.
